(19) United States
(12) Patent Application Publication
(10) Pub. No.: US 2013/0301069 A1
(43) Pub. Date: Nov. 14, 2013

(54) INFORMATION PROCESSING DEVICE, COMPUTER PROGRAM PRODUCT, AND IMAGE FORMING APPARATUS

(71) Applicant: Hideki YANAGI, Kanagawa (JP)

(72) Inventor: Hideki YANAGI, Kanagawa (JP)

(21) Appl. No.: 13/875,598

(22) Filed: May 2, 2013

(30) Foreign Application Priority Data
May 11, 2012 (JP) 2012-109601
Apr. 9, 2013 (JP) 2013-081394

(51) Int. Cl. G06F 3/12

(52) U.S. Cl. CPC G06F 3/1297
USPC 358/1.13

(57) ABSTRACT

To update a printer driver installed in an information processing device, the information processing device deletes a model dependent file of a model that is not present in a system environment of a user and that has been supported by the printer driver before being updated but is to be unsupported by the printer driver after being updated.

### CROSS-REFERENCE TO RELATED APPLICATIONS

The present application claims priority to and incorporates by reference the entire contents of Japanese Patent Application No. 2012-109601 filed in Japan on May 11, 2012 and Japanese Patent Application No. 2013-081394 filed in Japan on Apr. 9, 2013.

### BACKGROUND OF THE INVENTION

1. Field of the Invention

The present invention relates to an information processing device, a computer program product, and an image forming apparatus.

2. Description of the Related Art

The recent progress in digitization of information makes image processing devices, such as printers and facsimiles used for outputting digitized information and scanners used for digitizing a document, indispensable. Such image processing devices frequently have an image capturing function, an image forming function, a communication function, and other functions, thereby functioning as multifunction peripherals available as a printer, a facsimile, a scanner, and a copier.

To operate a printing apparatus used for outputting a digitized document among such image processing devices, a printer driver installed in an information processing devices, such as a personal computer (PC), typically generates a print command and transmits the print command to the printing apparatus. It is necessary to install the printer driver in the information processing devices that transmits the print command to the printing apparatus.

To use a plurality of printing apparatuses of different models, it is necessary to install printer drivers corresponding to the respective models in the information processing apparatus. Furthermore, to extend the functions of the printing apparatuses or to use a printing apparatus of another model, it is necessary to install printer drivers corresponding to the functions or the model in the information processing apparatus.

This puts a burden of development of the printer drivers on a manufacturer that markets the printing apparatuses and a burden of management of installed software on a user. A system that operates with a printing apparatus, a server, and a PC of each user connected to a network includes a printer driver installed in the PC of each user as a part of the system. To update the printer driver or to install a printer driver of another model, for example, it is necessary to check the operations of the system each time. This increases a burden and cost for a system administrator.

In view of the disadvantages described above, Japanese Patent Application Laid-open No. 2010-072804, for example, discloses a printer driver that can be shared by a plurality of printing apparatuses of different models as a universal driver. The universal driver disclosed in Japanese Patent Application Laid-open No. 2010-072804 includes a driver core unit and model dependent data. The driver core unit includes a function table that contains information indicating functions common to the models. The model dependent data contains information indicating functions of each model. The model dependent data is prepared for each model and contains information indicating all the functions provided to each model. The universal driver disclosed in Japanese Patent Application Laid-open No. 2010-072804 compares model dependent data of a certain model and the function table, thereby supporting functions included in both the model dependent data and the function table alone for the model. The universal driver disclosed in Japanese Patent Application Laid-open No. 2010-072804 determines functions included not in the function table but in the model dependent data to be unsupported functions. The universal driver displays a list of the functions on a display unit of a PC in which the universal driver is installed.

The universal driver disclosed in Japanese Patent Application Laid-open No. 2010-072804, however, can support only the functions included in both the function table and the model dependent data, that is, only the common denominator of the functions provided to the models. The universal driver fails to make full use of the functions unique to each model. To address this, there has been developed a universal driver that can support all the functions provided to printing apparatuses of any models to which a print command is to be transmitted. Such a universal driver typically includes a driver core unit and a model dependent file. The driver core unit is related to settings and functions common to the models. The model dependent file contains information related to settings and functions unique to each model and is prepared for each model.

An information processing device in which such a universal driver is installed displays a list of selectable models based on the model dependent file held by the universal driver.

As a result of updating the universal driver for an upgrade, for example, the driver core unit is updated, whereby a model that has been supported by the driver core unit of the previous version may possibly be unsupported by the driver core unit of the new version. In this case, the model dependent file of the model remains held in the universal driver despite of the model being unsupported by the new version. This causes the display screen of the information processing device to display the model supposed to be unsupported by the new version. As a result, the user can select the model supposed to be unsupported. The user may mistakenly assume that the model is supported or erroneously select and operate the model thus unsupported.

By contrast, as a result of updating the universal driver, the driver core unit is updated, whereby a model that has been unsupported by the driver core unit of the previous version may possibly be newly supported by the driver core unit of the new version. Even though the updating causes the new model to be supported, the model may not possibly be present in a system environment of the user. In this case, despite of the newly supported model not being present in the system environment of the user, the model dependent file of the model remains held in the universal driver. This causes the display screen of the information processing device to display the model not supposed to be present. As a result, the user may mistakenly assume that the model not supposed to be present is present in the system environment or erroneously select the model.

These problems do not necessarily occur in the printer driver of the printing apparatus. They can also occur in a device driver of a device incorporated in the information processing device, such as an expansion card including a network interface card (NIC), and in a device driver of a peripheral device externally connected to the information processing device, such as an input-output device including a graphic display and a sound speaker.

Therefore, there is a need for an information processing device capable of improving the convenience of a user in updating a universal driver installed in an information processing device for controlling apparatuses with a simple configuration.

### SUMMARY OF THE INVENTION

According to an embodiment, there is provided an information processing device that has an apparatus control program that provides a function to control an apparatus. The information processing device includes a model unique file storage unit, a model identification information list generating unit, a determining unit, a model unique file deleting unit, and an updating unit. The model unique file storage unit stores therein a model unique file containing model unique information that varies depending on each model of the apparatus. The model identification information list generating unit acquires model identification information used for identifying a model of the apparatus from the apparatus to generate a model identification information list that lists the model identification information thus acquired. The determining unit, to update the apparatus control program, determines whether or not a model unique file of a first model is stored in the model unique file storage unit. The first model is contained neither in a list of models supported by the apparatus control program after being updated nor in the model identification information list. When the determining unit determines that the model unique file of the first model is stored in the model unique file storage unit, the model unique file deleting unit deletes the model unique file of the first model from the model unique file storage unit. The updating unit that updates the apparatus control program when the model unique file deleting unit deletes the model unique file of the fist model.

According to another embodiment, there is provided a computer program product including a non-transitory computer-readable medium containing an apparatus control program for controlling an apparatus. The apparatus control program causes a computer, which includes a storage unit that stores therein a model unique file containing model unique information that varies depending on each model of the apparatus, to perform acquiring model identification information used for identifying a model of the apparatus from the apparatus to generate a model identification information list that lists the model identification information thus acquired; determining, to update the apparatus control program, whether or not a model unique file of a first model is stored in the storage unit, the first model being contained neither in a list of models supported by the apparatus control program after being updated nor in the model identification information list; deleting, when it is determined that the model unique file of the first model is stored in the storage unit, the model unique file of the first model from the storage unit; and updating the apparatus control program when the model unique file of the first model is deleted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an example of an operation form of a printing system according to an embodiment of the present invention;

FIG. 2 is a block diagram schematically illustrating a hardware configuration of an image forming apparatus according to the embodiment of the present invention;

FIG. 3 is a block diagram schematically illustrating a functional configuration of the image forming apparatus according to the embodiment of the present invention;

FIG. 4 is a block diagram schematically illustrating a functional configuration of a printer driver installed in a client terminal and a functional configuration of an installer required for updating the printer driver according to the embodiment of the present invention;

FIG. 5 is a schematic of an example of contents in supported model information of the installer according to the embodiment of the present invention;

FIG. 6 is a schematic of an example of contents in supported model information of the printer driver according to the embodiment of the present invention;

FIG. 7 is a schematic of model dependent files stored in a model dependent file storage unit of the printer driver before being updated (Ver. 1.0) according to the embodiment of the present invention;

FIG. 8 is a schematic of model dependent files stored in the model dependent file storage unit of the printer driver after being updated (Ver. 2.0) according to the embodiment of the present invention;

FIG. 9 is a flowchart for explaining an operation of updating the printer driver from Ver. 1.0 to Ver. 2.0 according to the embodiment of the present invention;

FIG. 10 is a schematic of a list of update environments according to the embodiment of the present invention;

FIG. 11 is a schematic of a display example of a confirmation and selection screen displayed on a display unit of the client terminal according to the embodiment of the present invention;

FIG. 12 is a flowchart for explaining an operation of displaying a list of models on the display unit of the client terminal according to the embodiment of the present invention;

FIG. 13 is a schematic of a list of usage environments in the printer driver before being updated (Ver. 1.0) according to the embodiment of the present invention;

FIG. 14 is a schematic of a list of usage environments in the printer driver after being updated (Ver. 2.0) according to the embodiment of the present invention;

FIG. 15 is a schematic of a display example of a model selection screen of a printer property in the printer driver before being updated (Ver. 1.0) according to the embodiment of the present invention;

FIG. 16 is a schematic of a display example of a model selection screen of a printer property in the printer driver after being updated (Ver. 2.0) according to the embodiment of the present invention;

FIG. 17 is a schematic of a display example of a warning screen of the printer driver according to the embodiment of the present invention;

FIG. 18 is a schematic of a display example of model dependent information of the printer property in the printer driver according to the embodiment of the present invention;

FIG. 19 is a flowchart for explaining an operation of updating a printer driver from Ver. 1.0 to Ver. 2.0 according to a modification of the embodiment of the present invention;

FIG. 20 is a schematic of a display example of a confirmation and selection screen for an installation method displayed on a display unit of a client terminal according to the modification of the embodiment of the present invention; and

FIG. 21 is a schematic of a display example of printer icons displayed on the display unit of the client terminal according to the modification of the embodiment of the present invention.

### DETAILED DESCRIPTION OF THE PREFERRED EMBODIMENTS

Embodiments according to the present invention are described below in greater detail with reference to the accompanying drawings. In an embodiment according to the present invention, an explanation will be made as an example in which a printing system includes an image forming apparatus serving as a printing apparatus and a client terminal serving as an information processing device such as a personal computer (PC), and a printer driver is installed in the client terminal, so as to allow the client terminal to control operations of the image forming apparatus. The printer driver according to the present embodiment is a universal driver shared by a plurality of models of the image forming apparatus and can be shared by any models supported by the universal driver.

After the printer driver installed in the client terminal is updated, the printing system according to the present embodiment can prevent a model that is supported but is not present in a system environment of a user and a model that is present in the system environment of the user but is unsupported from being set as a model to be used by the user. This can prevent the user from erroneously setting or operating a model not supposed to be used, thereby eliminating troubles of the user. The explanation will be made below in greater detail.

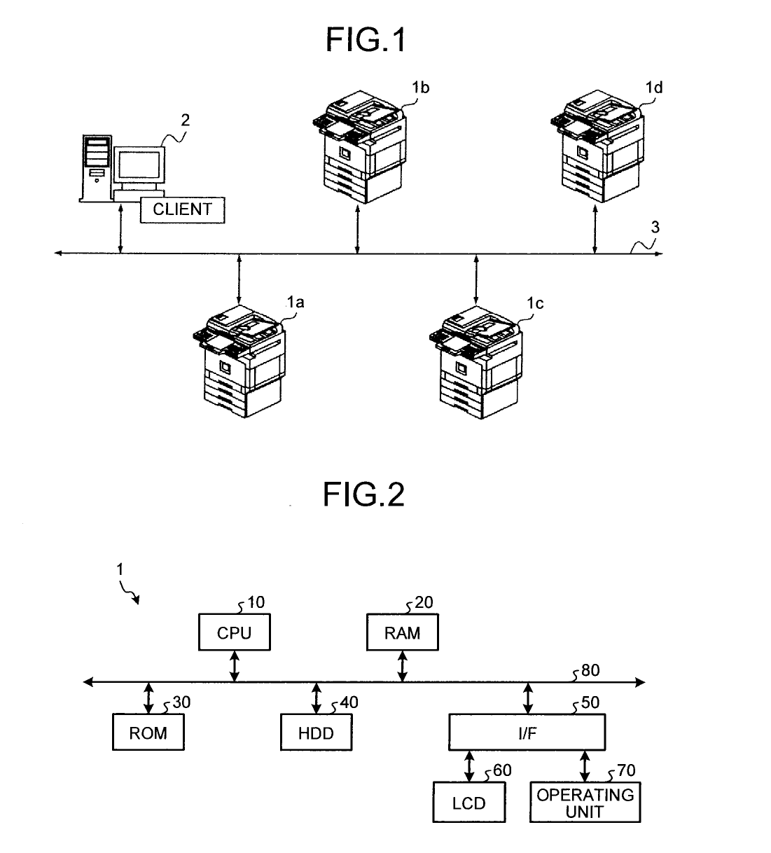

An operation form of the printing system according to the present embodiment will now be described with reference to FIG. 1. FIG. 1 is a schematic of an example of the operation form of the printing system according to the present embodiment. As illustrated in FIG. 1, the printing system according to the present embodiment is formed of an image forming apparatus 1a, an image forming apparatus 1b, an image forming apparatus 1c, an image forming apparatus 1d, and a client terminal 2. which are connected to one another via a network 3, such as Ethernet (registered trademark). The number of the image forming apparatuses and of the client terminal connected to the network 3 is given just as an example. The printing system may be a larger system in which more image forming apparatuses and client terminals are connected. The printing system may be formed by connecting image forming apparatuses and client terminals to different networks and connecting the networks to each other via a wide area network (WAN), such as a public line.

The image forming apparatuses 1a to 1d are multifunction peripherals (MFPs) available as a printer, a facsimile, a scanner, and a copier by having an image capturing function, an image forming function, a communication function, and other functions. The image forming apparatuses 1a to 1d generate CMYK or monochrome drawing information based on image information included in a print command transmitted from the client terminal 2 via the network 3 to form and output an image based on the drawing information thus generated. In other words, the image forming apparatuses 1a to 1d functions as color printers and monochrome printers. The image forming apparatuses 1a to 1d illustrated in FIG. 1 are models different from one another and have the model names of Model-A, Model-B, Model-C, and Model-D, respectively. The image forming apparatuses 1a to 1d are referred to as an image forming apparatus 1 if they are not particularly distinguished.

The client terminal 2 is an information processing terminal operated by the user and is provided as an information processing device, such as a PC. The client terminal 2 may be provided as a mobile information terminal such as a personal digital assistant (PDA), a smartphone, and a tablet terminal, for example. The client terminal 2 has a printer driver installed therein for controlling at least one model of the image forming apparatuses among Model-A to Model-D. The printer driver is a universal driver shared by a plurality of models as described above. The client terminal 2 according to the present embodiment generates a print command for causing an image forming apparatus of a model supported by the printer driver thus installed to perform printing based on a user operation. The client terminal then transmits the print command via the network 3.

While the network 3 in FIG. 1 is a limited network, such as an office local area network (LAN), the image forming apparatuses 1a to 1d and the client terminal 2 may be connected via a WAN, such as the Internet and a public line.

A hardware configuration of the image forming apparatus 1 and the client terminal 2 according to the present embodiment will now be described with reference to FIG. 2. FIG. 2 is a block diagram schematically illustrating the hardware configuration of the image forming apparatus 1 according to the present embodiment. The image forming apparatus 1 includes an engine that implements a scanner, a printer, and the like in addition to the hardware configuration illustrated in FIG. 2. While the hardware configuration of the image forming apparatus 1 will be described below as an example, the same applies to the client terminal 2.

As illustrated in FIG. 2, the image forming apparatus 1 according to the present embodiment has the same configuration as that of a typical server and PC, for example. In other words, the image forming apparatus 1 according to the present embodiment is formed of a central processing unit (CPU) 10, a random access memory (RAM) 20, a read-only memory (ROM) 30, a hard disk drive (HDD) 40, and an interface (I/F) 50 connected to one another via a bus 80. The I/F 50 is connected to a liquid crystal display (LCD) 60 and an operating unit 70.

The CPU 10 is an arithmetic unit and collectively controls operations of the image forming apparatus 1. The RAM 20 is a volatile storage medium from and to which information can be read and written at high speed and is used as a work area for the CPU 10 to process information. The ROM 30 is a non-volatile read-only storage medium and stores therein computer programs, such as firmware. The HDD 40 is a non-volatile storage medium from and to which information can be read and written and stores therein an operating system (OS), various control programs, and application programs, for example.

The I/F 50 connects the bus 80 to various types of hardware and networks, for example, and controls these components. The LCD 60 is a visual user interface with which the user checks the status of the image forming apparatus 1. The operating unit 70 is a user interface, such as a keyboard and a mouse, through which the user inputs information to the image forming apparatus 1.

In this hardware configuration, a computer program stored in the ROM 30, the HDD 40, or a storage medium such as an optical disk, which is not illustrated, is read to the RAM 20. The CPU 10 then carries out an operation in accordance with the computer program loaded on the RAM 20, thereby providing a software control unit. Combining the software control unit formed in this manner and hardware provides the functional blocks that carry out the functions of the image forming apparatus 1 according to the present embodiment.

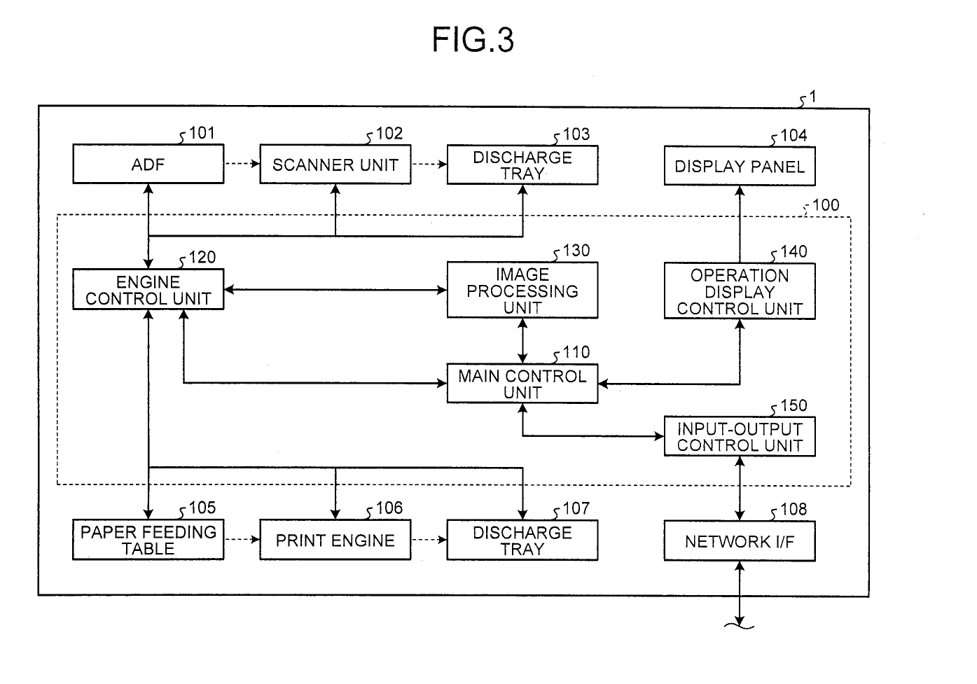

A functional configuration of the image forming apparatus 1 according to the present embodiment will now be described with reference to FIG. 3. FIG. 3 is a block diagram schematically illustrating the functional configuration of the image forming apparatus 1 according to the present embodiment. As illustrated in FIG. 3, the image forming apparatus 1 according to the present embodiment includes a controller 100, an automatic document feeder (ADF) 101, a scanner unit 102, a discharge tray 103, a display panel 104, a paper feeding table 105, a print engine 106, a discharge tray 107, and a network I/F 108.

The controller 100 includes a main control unit 110, an engine control unit 120, an image processing unit 130, an operation display control unit 140, and an input-output control unit 150. As illustrated in FIG. 3, the image forming apparatus 1 according to the present embodiment is configured as an MFP including the scanner unit 102 and the print engine 106. Electrical connections are indicated by solid arrows in FIG. 3, whereas flows of a sheet or a bundle of sheets are indicated by dashed arrows.

The display panel 104 is an output interface that visually displays the status of the image forming apparatus 1. The display panel 104 is also an input interface serving as a touch panel used by the user to directly operate the image forming apparatus 1 or input information to the image forming apparatus 1. In other words, the display panel 104 has a function to display an image used for receiving an operation performed by the user. The display panel 104 is formed of the LCD 60 and the operating unit 70 illustrated in FIG. 2.

The network I/F 108 is an interface that allows the image forming apparatus 1 to communicate with other devices, such as the client terminal 2, via the network. An Ethernet (registered trademark) interface or a universal serial bus (USB) interface is used as the network I/F 108. The network I/F 108 is formed of the I/F 50 illustrated in FIG. 2.

The controller 100 is formed as a combination of software and hardware. Specifically, a computer program stored in the ROM 30, a non-volatile memory, the HDD 40, or a non-volatile storage medium, such as an optical disk, is loaded on a volatile memory (hereinafter, referred to as a memory), such as the RAM 20. The CPU 10 then operates in accordance with the computer program, thereby providing a software control unit. Combining the software control unit and hardware, such as an integrated circuit, provides the controller 100. The controller 100 functions as a control unit that collectively controls the image forming apparatus 1.

The main control unit 110 controls each unit included in the controller 100 and issues instructions to each unit of the controller 100. The engine control unit 120 serves as a driving unit that controls or drives the print engine 106 and the scanner unit 102, for example.

The image processing unit 130 generates drawing information based on image information to be printed under the control of the main control unit 110. The drawing information is used by the print engine 106 serving as an image forming unit to draw an image to be formed in an image forming operation. The image processing unit 130 processes captured data received from the scanner unit 102 to generate image data. The image data is information stored in a storage area of the image forming apparatus 1 as a result of a scanning operation or transmitted to the client terminal 2 via the network I/F 108.

The operation display control unit 140 displays information on the display panel 104 or notifies the main control unit 110 of information received via the display panel 104. The input-output control unit 150 inputs information received via the network I/F 108 to the main control unit 110. The main control unit 110 controls the input-output control unit 150 to access other devices, such as the client terminal 2, via the network I/F 108 and the network 3.

The image forming apparatus 1 with this configuration operates as a printer as follows. The input-output control unit 150 receives a print job via the network I/F 108. The input-output control unit 150 transfers the print job thus received to the main control unit 110. If the main control unit 110 receives the print job, the main control unit 110 controls and causes the image processing unit 130 to generate drawing information based on document information or image information included in the print job.

After the image processing unit 130 generates the drawing information, the engine control unit 120 controls and causes the print engine 106 to form an image on a sheet conveyed from the paper feeding table 105 based on the drawing information thus generated. In other words, the image processing unit 130, the engine control unit 120, and the print engine 106 function as an image forming and output unit. Examples of specific configurations of the print engine 106 may include an ink-jet image forming mechanism and an electrophotography image forming mechanism. The document on which the image is formed by the print engine 106 is discharged onto the discharge tray 107.

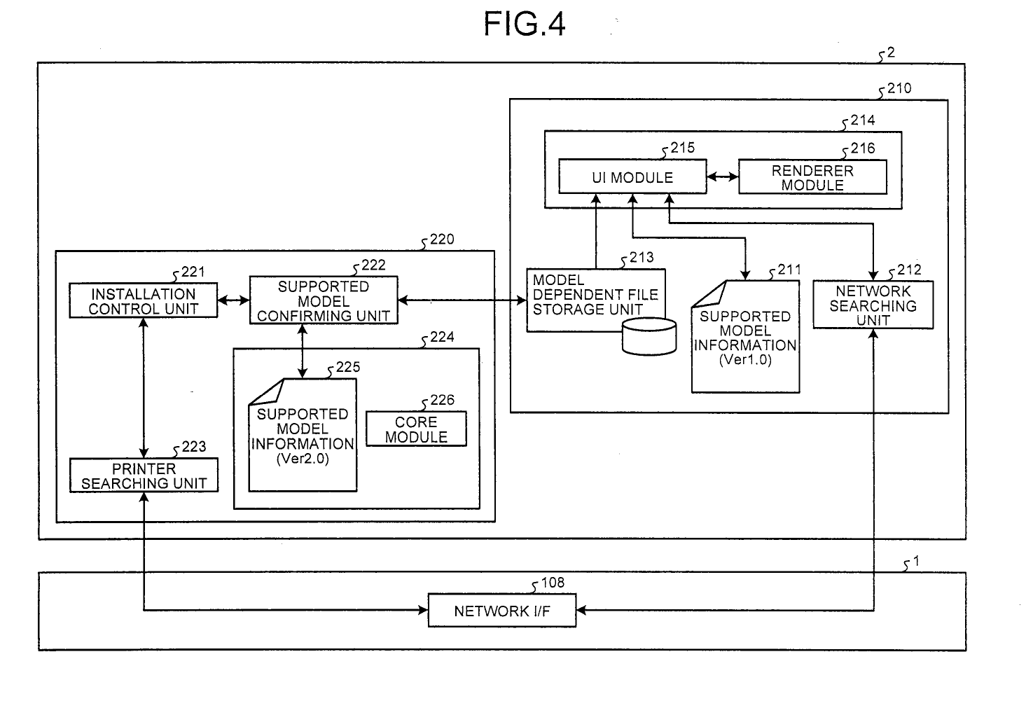

An explanation will be made of a functional configuration of the printer driver installed in the client terminal 2 and a functional configuration of an installer required for updating the printer driver according to the present embodiment with reference to FIG. 4. FIG. 4 is a block diagram schematically illustrating the functional configuration of the printer driver installed in the client terminal 2 and the functional configuration of the installer required for updating the printer driver according to the present embodiment. In the present embodiment, the version of the printer driver that has already been installed in the client terminal 2, that is, the version of the printer driver before being updated is Ver. 1.0, and the version thereof after being updated is Ver. 2.0. In FIG. 4, components denoted by reference numerals similar to those in FIG. 3 correspond to the same or equivalent components.

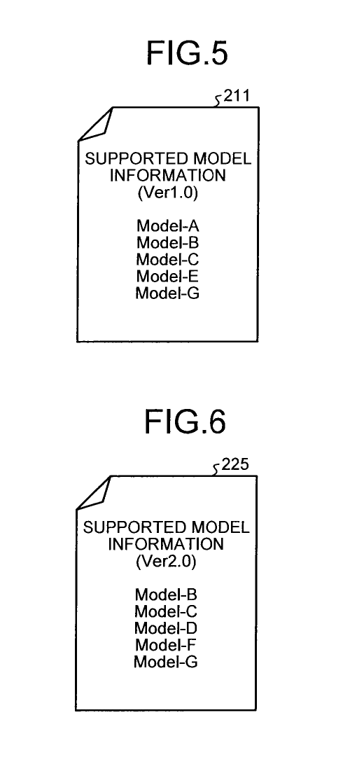

In the explanation below, an assumption is made that the printer driver before being updated, that is, the printer driver of Ver. 1.0 supports models of Model-A, Model-B, Model-C, Model-E, and Model-G; whereas the printer driver after being updated, that is, the printer driver of Ver. 2.0 supports models of Model-B, Model-C, Model-D, Model-F, and Model-G. Lists of the models supported by the printer driver of the respective versions are contained in supported model information 211 and supported model information 225, which will be described later, as illustrated in FIG. 5 and FIG. 6, respectively.

As illustrated in FIG. 4, the client terminal 2 according to the present embodiment needs to use an installer 220 to update a printer driver 210 installed therein. The printer driver 210 is a universal printer driver shared by a plurality of models as described above. As illustrated in FIG. 4, the printer driver 210 includes supported model information 211, a network searching unit 212, a model dependent file storage unit 213, and a driver core unit 214. The installer 220 is a computer program that causes the printer driver 210 to be updated in the client terminal 2. The installer 220 includes an installation control unit 221, a supported model confirming unit 222, a printer searching unit 223, and a driver module 224.

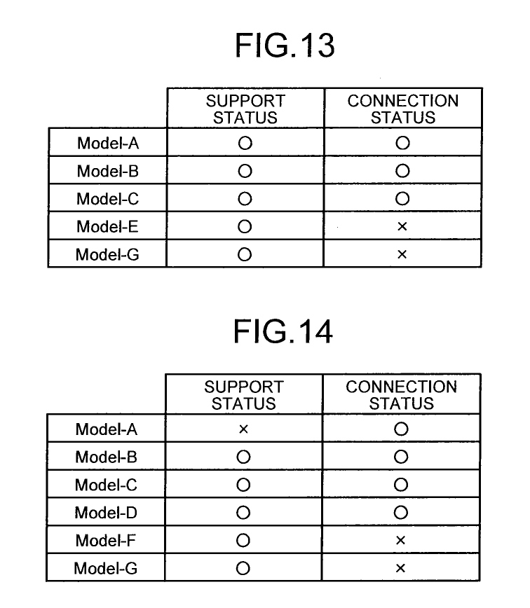

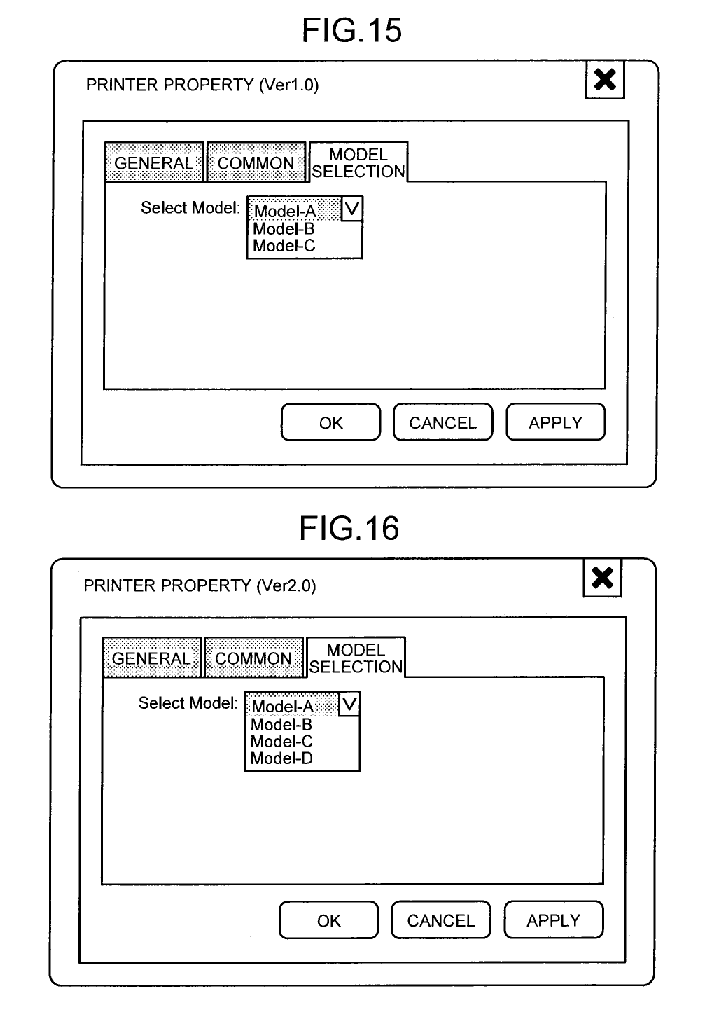

The driver core unit 214 is a functional unit that provides basic functions of the printer driver 210 as a printer driver and includes a user interface (UI) module 215 and a renderer module 216. The UI module 215 displays a graphical user interface (GUI), such as a property screen of the image forming apparatus 1, on a display unit of the client terminal 2. In other words, the UI module 215 functions as a property display unit in the present embodiment. Examples of the screen displayed by the UI module 215 on the display unit of the client terminal 2 will be described later with reference to FIG. 15 to FIG. 18. The UI module 215 generates a list of usage environments illustrated in FIG. 13 and FIG. 14. The list of usage environments will be described later. The renderer module 216 carries out rendering based on image information included in a print command, thereby generating drawing information used for printing.

The supported model information 211 is a file containing a list of model information (model names) supported by the printer driver 210 before being updated, that is, the printer driver 210 of Ver. 1.0. FIG. 5 illustrates contents in the supported model information 211 according to the present embodiment. The printer driver 210 before being updated according to the present embodiment, that is, the printer driver 210 of Ver. 1.0 supports the models of Model-A, Model-B, Model-C, Model-E, and Model-G. The supported model information 211 contains a list of model information (model names) corresponding to the models as illustrated in FIG. 5. In other words, the supported model information 211 indicates a list of supported models in the present embodiment.

The network searching unit 212 searches for image forming apparatuses connected to the client terminal 2 via a LAN or a USB under the control of the UI module 215. The network searching unit 212 acquires model information of the image forming apparatuses connected to the client terminal 2 as a result of the searching. The network searching unit 212 then generates a list of models of the image forming apparatuses connected to the client terminal 2 (hereinafter, referred to as a “list of connected models”) based on the model information thus acquired. The network searching unit 212 performs the searching in response to an instruction issued by the UI module 215. Specifically, the network searching unit 212 performs the searching by transmitting an acquisition request of model information, which will be described later, to the image forming apparatuses connected to the client terminal 2 and receiving the reply.

The model dependent file storage unit 213 stores therein a model dependent file serving as a model dependent unit of the printer driver 210 that has been already installed. The model dependent file is provided for each model and indicates settings and functions unique to each model (hereinafter, referred to as “model dependent information”). Examples of the model dependent information may include management of colors, available sheet sizes, resolution, sheet types that can be used for printing, availability of collective printing, and availability of duplex printing. In other words, the model dependent information corresponds to model unique information, and the model dependent file corresponds to a model unique file in the present embodiment. The model dependent file storage unit 213 functions as a model unique file storage unit.

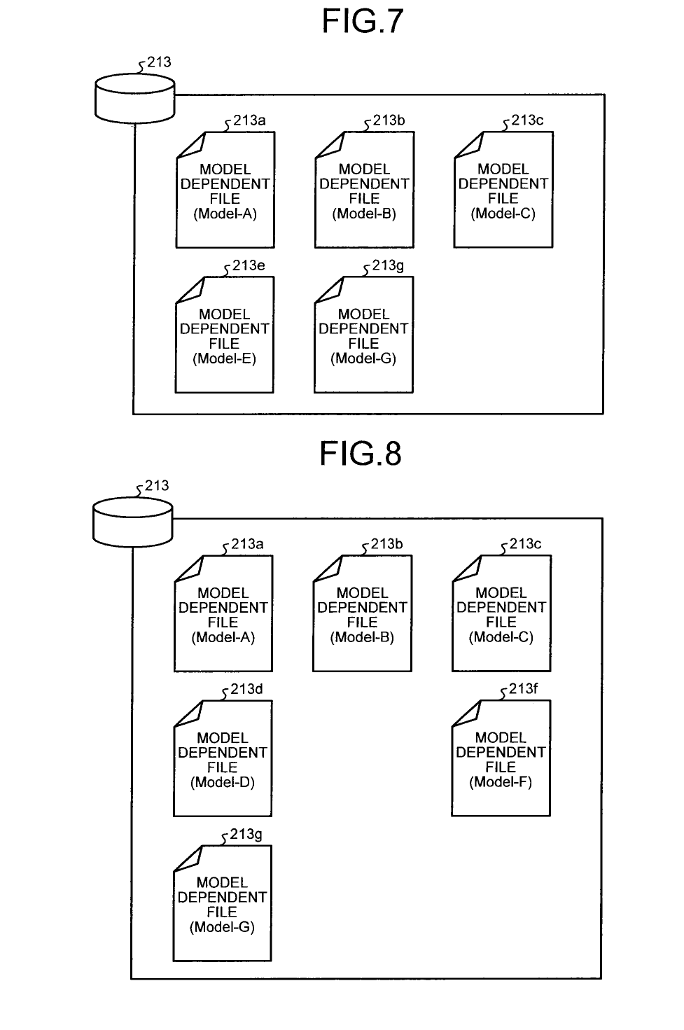

FIG. 7 illustrates model dependent files stored in the model dependent file storage unit 213 according to the present embodiment. The printer driver 210 before being updated according to the present embodiment, that is, the printer driver 210 of Ver. 1.0 supports the models of Model-A, Model-B, Model-C, Model-E, and Model-G. The model dependent file storage unit 213 according to the present embodiment stores therein model dependent files 213a, 213b, 213c, 213e, and 213g corresponding to the respective models as illustrated in FIG. 7. In other words, the model dependent files 213a, 213b, 213c, 213e, and 213g correspond to the models of image forming apparatuses of Model-A, Model-B, Model-C, Model-E, and Model-G, respectively.

The model dependent file storage unit 213 according to the present embodiment in the printer driver 210 after being updated, that is, the printer driver 210 of Ver. 2.0 stores therein model dependent files 213a, 213b, 213c, 213d, 213f, and 213g as illustrated in FIG. 8 for a reason described later. The model dependent files 213a, 213b, 213c, 213d, 213f, and 213g correspond to models of image forming apparatuses of Model-A, Model-B, Model-C, Model-D, Model-F, and Model-G, respectively.

The driver module 224 is a functional unit that provides basic functions of the printer driver 210 after being updated, that is, the printer driver 210 of Ver. 2.0 as a printer driver. The driver module 224 includes a supported model information 225 and a core module 226. The supported model information 225 is a file containing a list of model information (model names) supported by the printer driver 210 after being updated, that is, the printer driver 210 of Ver. 2.0. FIG. 6 illustrates contents in the supported model information 225 according to the present embodiment. The printer driver 210 after being updated according to the present embodiment, that is, the printer driver 210 of Ver. 2.0 supports the models of Model-B, Model-C, Model-D, Model-F, and Model-G. The supported model information 225 contains a list of model information (model names) corresponding to the models as illustrated in FIG. 6. In other words, the supported model information 225 indicates a list of models supported by the printer driver 210 after being updated in the present embodiment.

The core module 226 is a main body of a printer driver installed in the client terminal 2 to update the printer driver 210. The installation control unit 221 controls processing related to updating of the printer driver 210 and issues instructions to each unit of the installer 220. Specifically, the installation control unit 221 controls installation of the driver module 224 in the client terminal 2, for example. The installation control unit 221 displays a GUI, such as an operation screen used when updating the printer driver 210, on the display unit of the client terminal 2. Examples of the screen displayed by the installation control unit 221 on the display unit of the client terminal 2 will be described later with reference to FIG. 11.

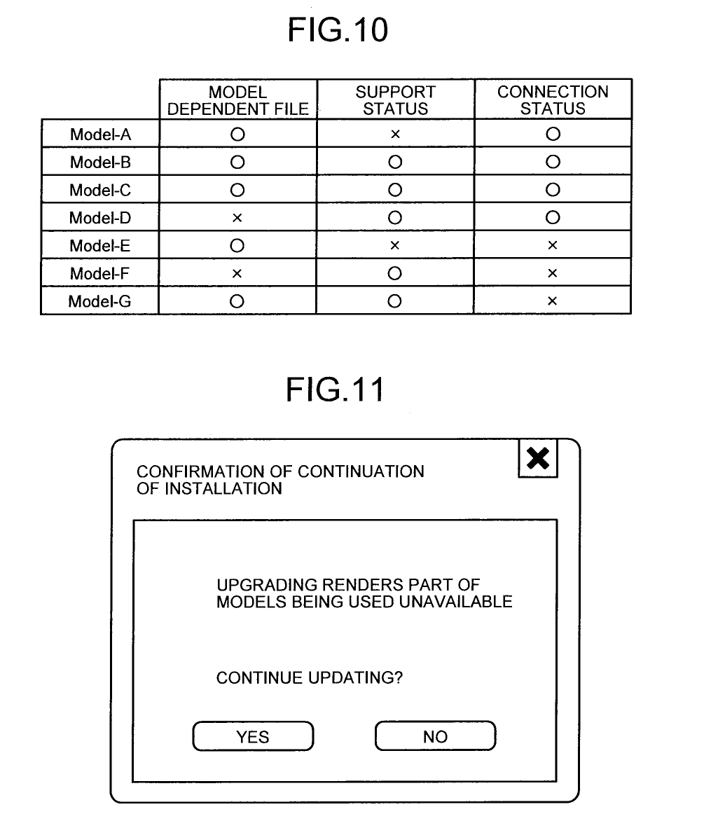

The supported model confirming unit 222 generates a list of update environments illustrated in FIG. 10 in accordance with an instruction issued by the installation control unit 221. The list of update environments will be described later. The printer searching unit 223 searches for image forming apparatuses connected to the client terminal 2 via the LAN or the USB. The printer searching unit 223 acquires model information of the image forming apparatuses connected to the client terminal 2 as a result of the searching to generate a list of connected models based on the model information thus acquired. In other words, the model information corresponds to model identification information, and the list of connected models corresponds to a model identification information list in the present embodiment. The network searching unit 212 or the printer searching unit 223 functions as a model identification information list generating unit. The printer searching unit 223 performs the searching in response to an instruction issued by the installation control unit 221. Specifically, the printer searching unit 223 performs the searching by transmitting an acquisition request of model information, which will be described later, to the image forming apparatuses connected to the client terminal 2 and receiving the reply.

The image forming apparatuses la to ld each transmit the model information via the network I/F 108 in response to the acquisition request of model information transmitted from the client terminal 2. The acquisition request of model information is information transmitted from the client terminal 2 to the image forming apparatuses la to ld so as to cause the image forming apparatuses la to ld to transmit the model names thereof as the model information. If the image forming apparatus la receives the acquisition request of model information from the client terminal 2 via the network I/F 108, for example, the image forming apparatus 1a transmits Model-A to the client terminal 2 via the network I/F 108 as the model information.

In the printing system with this configuration according to the present embodiment, if there is a model that is present in the system environment of the user and that has been supported by a previous version but is to be unsupported by a new version as a result of updating a printer driver installed in a client terminal, it is possible to display a screen that causes the user to select whether to continue the updating on the display screen of the client terminal. This prevents a model that has been used by the user from becoming unavailable as a result of the updating without the user knowing it, thereby improving the convenience of the user.

Further, in the printing system with this configuration according to the present embodiment, if a model that has been supported by the previous version but is unsupported by the new version as a result of updating the printer driver installed in the client terminal is present in the system environment of the user, it is possible to display the model in a list of models on the display screen of the client terminal and to prevent the model from being set as a model that is to be used by the user. This enables the user to know all the models present in the system environment of the user. Furthermore, this can prevent the user from erroneously setting or operating a model not supposed to be used, thereby eliminating troubles of the user.

Furthermore, in the printing system with this configuration according to the present embodiment, if a model that has been unsupported by the previous version but is supported by the new version as a result of updating the printer driver installed in the client terminal is not present in the system environment of the user, it is possible to prevent the model from being displayed in the list of models on the display screen of the client terminal. This can prevent the user from erroneously selecting a model that is not present in the system environment of the user, thereby eliminating troubles of the user.

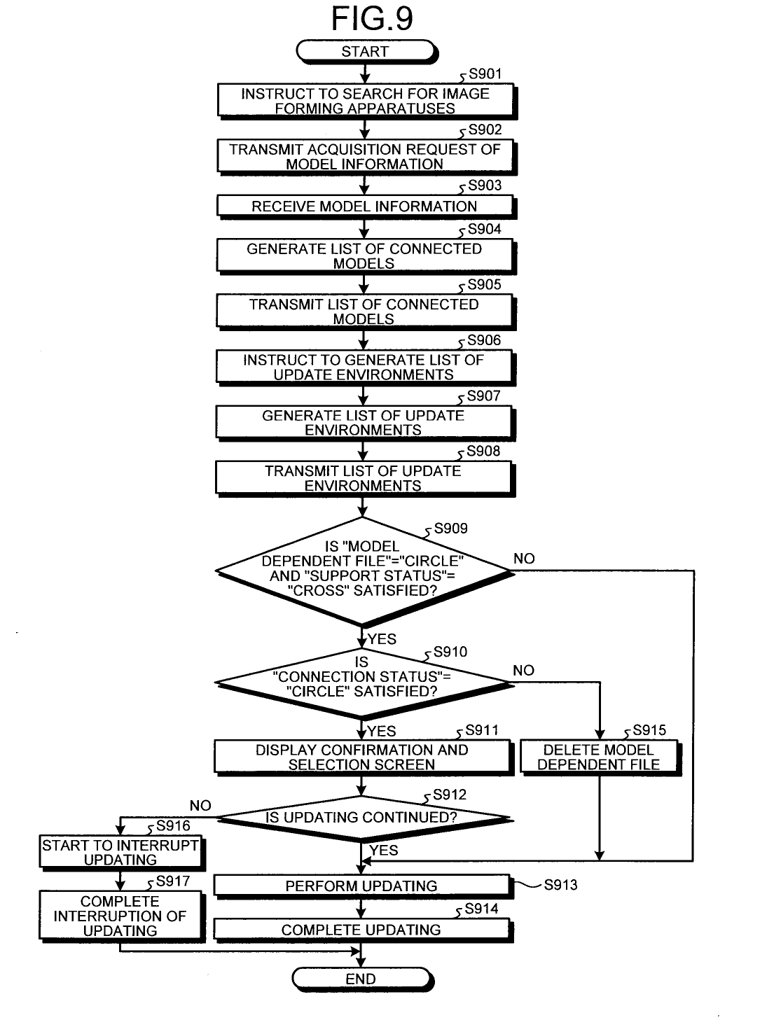

An explanation will be made of an operation of updating the printer driver 210 from Ver. 1.0 to Ver. 2.0 performed by the client terminal 2 according to the present embodiment with reference to FIG. 9. FIG. 9 is a flowchart for explaining the operation of updating the printer driver 210 from Ver. 1.0 to Ver. 2.0 according to the present embodiment. As illustrated in FIG. 9, to update the printer driver 210 according to the present embodiment from Ver. 1.0 to Ver. 2.0, the installation control unit 221 instructs the printer searching unit 223 to search for image forming apparatuses connected to the client terminal 2 (S901). In accordance with the instruction issued from the installation control unit 221, the printer searching unit 223 transmits an acquisition request of model information simultaneously to all the image forming apparatuses on the network by a broadcast and the like (S902).

The printer searching unit 223 receives model information from the image forming apparatuses on the network (S903). The printer searching unit 223 then generates a list of models of the image forming apparatuses connected to the client terminal 2 (a list of connected models) based on the model information thus received (S904) and transmits the list of connected models to the installation control unit 221 (S905). In the printing system according to the present embodiment, the image forming apparatuses of the models of Model-A, Model-B, Model-C, and Model-D are connected to the client terminal 2 as illustrated in FIG. 1. The printer searching unit 223 receives, as the model information, the model names of Model-A, Model-B, Model-C, and Model-D from the respective image forming apparatuses.

If the installation control unit 221 receives the list of connected models from the printer searching unit 223, the installation control unit 221 instructs the supported model confirming unit 222 to generate a list of update environments (S906). In accordance with the instruction issued from the installation control unit 221, the supported model confirming unit 222 generates a list of update environments from the supported model information 225, a list of model information (model names) of model dependent files stored in the model dependent file storage unit 213 (hereinafter, referred to as a “list of model dependent files”), and the list of connected models generated by the printer searching unit 223 (S907). In the list of update environments, each model supported by the printer driver of Ver. 1.0 or Ver. 2.0 is associated with the following items: whether the model dependent file of the model is present in the model dependent file storage unit 213 before being updated; whether the model is supported by the printer driver of Ver. 2.0; and whether the model is connected to the client terminal 2.

The list of update environments according to the present embodiment is illustrated in FIG. 10. FIG. 10 is a schematic of the list of update environments according to the present embodiment. As illustrated in FIG. 10, the list of update environments according to the present embodiment stores therein items of “model dependent file”, “support status”, and “connection status” for each model of the image forming apparatuses.

The “model dependent file” in the list of update environments indicates whether the model dependent file of each model is stored in the model dependent file storage unit 213 before being updated. In the item of “model dependent file” of FIG. 10, a model whose model dependent file is stored in the model dependent file storage unit 213 before being updated is marked with a “circle”, whereas a model whose model dependent file is not stored in the model dependent file storage unit 213 is marked with a “cross”. The item of “support status” in the list of update environments indicates whether each model is supported by the printer driver of Ver. 2.0.

In the item of “support status” of FIG. 10, a model supported by the printer driver of Ver. 2.0 is marked with a “circle”, whereas a model unsupported by the printer driver of Ver. 2.0 is marked with a “cross”. The “connection status” in the list of update environments indicates whether each model is connected to the client terminal 2. In the item of “connection status” of FIG. 10, a model connected to the client terminal 2 is marked with a “circle”, whereas a model that is not connected to the client terminal 2 is marked with a “cross”.

If the supported model confirming unit 222 generates the list of update environments, the supported model confirming unit 222 transmits the list of update environments to the installation control unit 221 (S908). If the installation control unit 221 receives the list of update environments, the installation control unit 221 determines whether there is a model whose item of “model dependent file” is marked with a “circle” and whose item of “support status” is marked with a “cross” in the list of update environments (S909). In other words, the installation control unit 221 determines whether the model dependent file storage unit 213 before being updated stores therein a model dependent file of a model unsupported by the printer driver of Ver. 2.0.

If the installation control unit 221 determines that there is no model whose item of “model dependent file” is marked with a “circle” and whose item of “support status” is marked with a “cross” in the list of update environments at S909 (No at S909), the installation control unit 221 performs updating without any change (S913). To perform the updating at S913, the installation control unit 221 generates model dependent files of models included in the supported model information 211 and stores the model dependent files in the model dependent file storage unit 213. At this time, no model dependent file is generated for the models already stored in the model dependent file storage unit 213.

In this case (No at S909), because updating the printer driver 210 from Ver. 1.0 to Ver. 2.0 renders no model that has been supported before the updating unsupported and unavailable after the updating. Performing the updating without any change does not cause any inconvenience to the user. In this case (No at S909), the installation control unit 221 performs the updating without any change. With this configuration, the client terminal 2 according to the present embodiment can automatically determine the system environment of the user to perform the updating. Thus, it is possible to reduce the troubles and improve the convenience of the user. After the updating is completed (S914), the client terminal 2 finishes the operation of updating the printer driver 210 from Ver. 1.0 to Ver. 2.0.

By contrast, if the installation control unit 221 determines that there is a model whose item of “model dependent file” is marked with a “circle” and whose item of “support status” is marked with a “cross” in the list of update environments at S909 (Yes at S909), the installation control unit 221 checks the item of “connection status” of the model to determine whether the model is connected to the client terminal 2 (S910). If the installation control unit 221 determines that a “cross” is allocated to the item of “connection status” of the model whose item of “model dependent file” is marked with a “circle” and whose item of “support status” is marked with a “cross” at S910 (No at S910), the installation control unit 221 deletes the model dependent file of the model (S915). In the present embodiment, the list of update environments illustrated in FIG. 10 indicates that the model dependent file 213e of Model-E satisfying the conditions described above is deleted from the model dependent file storage unit 213. In other words, the installation control unit 221 functions as a determining unit and a model unique file deleting unit.

In this case (No at S910), updating the printer driver 210 from Ver. 1.0 to Ver. 2.0 renders the model that has been supported before the updating unsupported and unavailable after the updating. Because the model has not been connected to the client terminal 2 before the updating, it is unlikely that the model is used after this. In this case (No at S910), updating the printer driver 210 after deleting the model dependent file of the model does not cause any inconvenience to the user. Thus, the installation control unit 221 performs the updating after deleting the model dependent file of the model. In other words, the installation control unit 221 functions as an updating unit.

With this configuration, the client terminal 2 according to the present embodiment can automatically delete a useless model dependent file transparently. Thus, it is possible to lighten the system without causing troubles to the user. With this configuration, the client terminal 2 according to the present embodiment displays no model that is not present in the system environment of the user in a list of models on a model selection screen, which will be described later. This can prevent the user from erroneously selecting the model, thereby eliminating troubles of the user. After deleting the model dependent file of the model, the installation control unit 221 performs the updating (S913). After the updating is completed (S914), the client terminal 2 finishes the operation of updating the printer driver 210 from Ver. 1.0 to Ver. 2.0.

If the installation control unit 221 determines that a “circle” is allocated to the item of “connection status” of the model whose item of “model dependent file” is marked with a “circle” and whose item of “support status” is marked with a “cross” at S910 (Yes at S910), the installation control unit 221 displays a confirmation and selection screen that causes the user to select whether to continue the updating on the display unit (display panel 104) of the client terminal 2 (S911). A display example of the confirmation and selection screen is illustrated in FIG. 11. FIG. 11 is a schematic of a display example of the confirmation and selection screen displayed on the display unit of the client terminal 2 according to the present embodiment. The user performs an operation in accordance with an instruction on the confirmation and selection screen displayed on the display screen of the client terminal 2 as illustrated in FIG. 11, thereby selecting whether to continue the updating. In other words, the confirmation and selection screen corresponds to a performance selection screen, and the installation control unit 221 functions as a performance selection screen display unit.

In this case (Yes at S910), updating the printer driver 210 from Ver. 1.0 to Ver. 2.0 renders the model that has been used by the user before the updating unsupported and unavailable after the updating. This causes troubles to the user. In this case (Yes at S910), the installation control unit 221 displays the confirmation and selection screen on the display unit of the client terminal 2, thereby enabling the user to explicitly select whether to continue the updating. With this configuration, the client terminal 2 according to the present embodiment can prevent an unexpected situation occurring in association with the updating, such as the image forming apparatus that has been used becoming unavailable without the user knowing it.

In this case (Yes at S910), the confirmation and selection screen displayed at S911 may display a list of models that become unavailable. Even if it is determined that a “circle” is allocated to the item of “connection status” of the model whose item of “model dependent file” is marked with a “circle” and whose item of “support status” is marked with a “cross” at S910 (Yes at S910), the confirmation and selection screen may not be displayed as long as the model is unsupported by the printer driver before the installation, that is, the printer driver of Ver. 1.0. This is because the model that has been unavailable for the user before the updating remains unavailable after the updating. In this case, updating without displaying the confirmation and selection screen does not cause any inconvenience to the user.

If the installation control unit 221 determines not to continue the updating based on the operation performed by the user on the confirmation and selection screen of the client terminal 2 (No at S912), the installation control unit 221 starts interruption operation of the updating (S916). If the installation control unit 221 completes the interruption operation of the updating (S917), the client terminal 2 interrupts the updating and finishes the operation of updating the printer driver 210 from Ver. 1.0 to Ver. 2.0 on the way.

By contrast, if the installation control unit 221 determines to continue the updating based on the operation performed by the user on the confirmation and selection screen of the client terminal 2 (Yes at S912), the installation control unit 221 continues the updating (S913). At this time, the installation control unit 221 deletes no model dependent file in the present embodiment. As a result, the list of models on the model selection screen of the printer property after the updating displays Model-A supposed to be unsupported by the printer driver of Ver. 2.0 in a selectable manner. In this configuration, the user can select Model-A thus unsupported but cannot set Model-A as an available printer, which will be described later. This prevents the user from erroneously operating the printer of Model-A.

In another embodiment, the installation control unit 221 may delete a model dependent file of a model unsupported by the printer driver of Ver. 2.0 from the model dependent file storage unit 213 when performing the updating. With this configuration, the installation control unit 221 deletes the model dependent file 213a from the model dependent file storage unit 213 when performing the updating. As a result, the list of models on the model selection screen of the printer property after the updating does not display Model-A unsupported by the printer driver of Ver. 2.0 from the first. With this configuration, the client terminal 2 according to the present embodiment displays no model that is unavailable in the system environment of the user on the model selection screen from the first. Thus, it is possible to eliminate troubles of the user.

If the installation control unit 221 completes the updating (S914), the client terminal 2 finishes the operation of updating the printer driver 210 from Ver. 1.0 to Ver. 2.0.

By performing the processing described above, the model names of Model-A, Model-B, Model-C, Model-D, Model-F, and Model-G are stored in the model dependent file storage unit 213 after being updated as illustrated in FIG. 8.

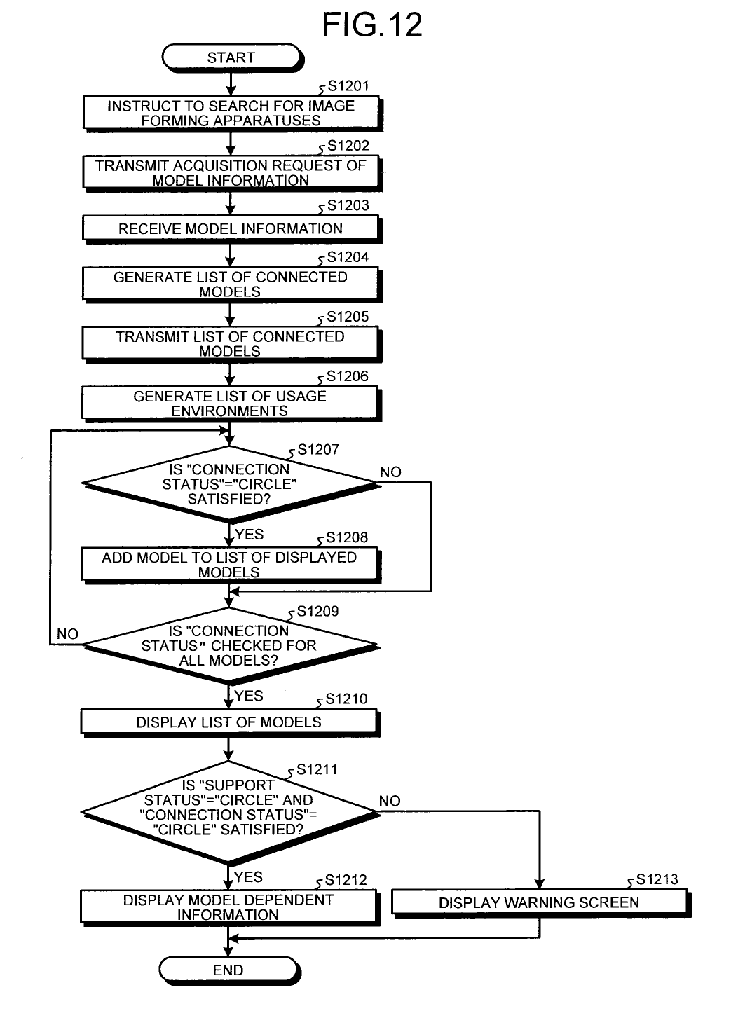

An explanation will be made of an operation of displaying the list of models on the display unit of the client terminal 2 according to the present embodiment with reference to FIG. 12. FIG. 12 is a flowchart for explaining the operation of displaying the list of models on the display unit of the client terminal 2 according to the present embodiment. The list of models is displayed on the model selection screen of the printer property displayed on the display unit of the client terminal 2 in the present embodiment.

To display the list of models on the display unit of the client terminal 2 according to the present embodiment, the user needs to operate the client terminal 2 and activate the printer property of the printer driver 210. If the printer property starts to activate, the UI module 215 instructs the network searching unit 212 to search for image forming apparatuses connected to the client terminal 2 as illustrated in FIG. 12 (S1201). In accordance with the instruction issued from the UI module 215, the network searching unit 212 transmits an acquisition request of model information simultaneously to all the image forming apparatuses on the network by a broadcast and the like (S1202).

The network searching unit 212 receives model information from the image forming apparatuses on the network (S1203). The network searching unit 212 then generates a list of models of the image forming apparatuses connected to the client terminal 2 (a list of connected models) based on the model information thus received (S1204) and transmits the list of connected models to the UI module 215 (S1205). In the printing system according to the present embodiment, the image forming apparatuses of the models of Model-A, Model-B, Model-C, and Model-D are connected to the client terminal 2 as illustrated in FIG. 1. The network searching unit 212 receives, as the model information, the names of Model-A, Model-B, Model-C, and Model-D from the respective image forming apparatuses.

If the UI module 215 receives the list of connected models from the network searching unit 212, the UI module 215 generates a list of usage environments from the supported model information 211, the list of model dependent files, and the list of connected models generated by the network searching unit 212 (S1206). In the list of usage environments, each of the models of the model dependent files stored in the model dependent file storage unit 213 is associated with the following items: whether the model is supported by the printer driver installed in the client terminal 2; and whether the model is connected to the client terminal 2.

The list of usage environments according to the present embodiment is illustrated in FIGS. 13 and 14. FIG. 13 is a schematic of the list of usage environments in the printer driver before being updated, that is, the printer driver of Ver. 1.0. FIG. 14 is a schematic of the list of usage environments in the printer driver after being updated, that is, the printer driver of Ver. 2.0. As illustrated in FIGS. 13 and 14, the list of usage environments according to the present embodiment stores therein items of “support status” and “connection status” for each model of the image forming apparatuses.

The item of “support status” in the list of usage environments indicates whether each model is supported by the printer driver installed in the client terminal 2. In the item of “support status” of FIGS. 13 and 14, a model supported by the printer driver installed in the client terminal 2 is marked with a “circle”, whereas a model unsupported by the printer driver is marked with a “cross”. The “connection status” in the list of usage environments indicates whether each model is connected to the client terminal 2. In the item of “connection status” of FIGS. 13 and 14, a model connected to the client terminal 2 is marked with a “circle”, whereas a model that is not connected to the client terminal 2 is marked with a “cross”.

If the UI module 215 generates the list of usage environments, the UI module 215 checks the item of “connection status” of each model in the list of usage environments to determine whether the model is connected to the client terminal 2 (S1207). In other words, the UI module 215 determines whether each of the models of the model files stored in the model dependent file storage unit 213 is connected to the client terminal 2.

The UI module 215 adds a model whose item of “connection status” is determined to be marked with a “circle” in the list of usage environments at S1207 (Yes at S1207), that is, a model connected to the client terminal 2 to a list of displayed models (S1208). The UI module 215 repeats the operations at S1207 and S1208 for the models of all the model dependent files stored in the model dependent file storage unit 213 (No at S1209). If the UI module 215 performs the operations at S1207 and S1208 on all the models (Yes at S1209), the UI module 215 displays a list of model names included in the list of displayed models on the model selection screen of the printer property displayed on the display unit of the client terminal 2 in a selectable manner (S1210).

FIG. 15 illustrates a display example of the list of models displayed on the model selection screen of the printer property displayed on the display unit of the client terminal 2 to which the printer driver before being updated (Ver. 1.0) is installed. FIG. 15 is a schematic of a display example of the model selection screen of the printer property displayed on the display unit of the client terminal 2 to which the printer driver before being updated (Ver. 1.0) is installed. As illustrated in FIG. 15, Model-A, Model-B, and Model-C are displayed in a selectable manner on the model selection screen of the printer property displayed on the display unit of the client terminal 2 to which the printer driver before being updated (Ver. 1.0) is installed. This is because the model dependent file storage unit 213 before being updated (Ver. 1.0) stores therein the model dependent files 213a, 213b, 213c, 213e, and 213g as illustrated in FIG. 7 and the image forming apparatuses of the models of Model-A, Model-B, Model-C, and Model-D are connected to the client terminal 2.

FIG. 16 illustrates a display example of the list of models displayed on the model selection screen of the printer property displayed on the display unit of the client terminal 2 to which the printer driver after being updated (Ver. 2.0) is installed. FIG. 16 is a schematic of a display example of the model selection screen of the printer property displayed on the display unit of the client terminal 2 to which the printer driver after being updated (Ver. 2.0) is installed. As illustrated in FIG. 16, Model-A, Model-B, Model-C, and Model-D are displayed in a selectable manner on the model selection screen of the printer property displayed on the display unit of the client terminal 2 to which the printer driver after being updated (Ver. 2.0) is installed. This is because the model dependent file storage unit 213 after being updated (Ver. 2.0) stores therein the model dependent files 213a, 213b, 213c, 213d, 213f, and 213g as illustrated in FIG. 8 and the image forming apparatuses of the models of Model-A, Model-B, Model-C, and Model-D are connected to the client terminal 2.

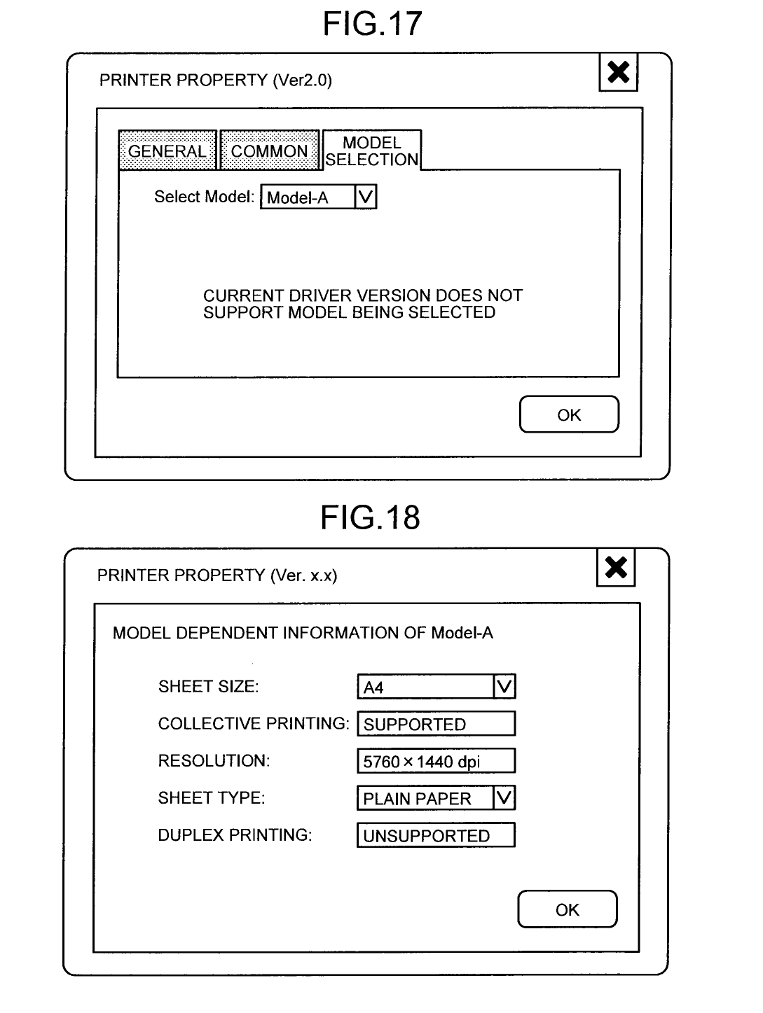

If the UI module 215 determines that a model whose item of “support status” is marked with a “cross” and whose item of “connection status” is marked with a “circle” in the list of usage environments is selected based on the operation performed by the user on the model selection screen of the client terminal 2 (No at S1211), the UI module 215 displays a warning screen on the display unit of the client terminal 2 (S1213). The warning screen notifies the user that the model thus selected is unsupported by the printer driver of the version installed in the client terminal 2. A display example of the warning screen is illustrated in FIG. 17. FIG. 17 is a schematic of a display example of the warning screen displayed on the display unit of the client terminal 2 according to the present embodiment. If the user operates the client terminal 2 to select Model-A on the model selection screen after being updated (Ver. 2.0) illustrated in FIG. 16, the user can find that Model-A is unsupported by the printer driver of Ver. 2.0 as illustrated in FIG. 17.

In this case (No at S1211), the model connected to the client terminal 2 but unsupported by the printer driver is selected. Setting the model as a printer to be used by the user without any change may possibly cause the user to mistakenly assume that the model is available. In this case (No at S1211), displaying the warning screen on the display unit of the client terminal 2 makes it possible to clearly notify the user that the model thus selected is unsupported.

With this configuration, the client terminal 2 according to the present embodiment enables the user to know all the models present in the system environment of the user. In addition, the client terminal 2 can prevent an unsupported model from being set as a printer that can be used by the user. The client terminal 2 according to the present embodiment can prevent the user from erroneously setting or operating a model not supposed to be used, thereby eliminating troubles of the user.

If the UI module 215 displays the warning screen on the display unit of the client terminal 2 (S1213), the client terminal 2 finishes the operation of displaying the list of models on the display unit.

If the UI module 215 determines that a model whose item of “support status” is marked with a “circle” and whose item of “connection status” is marked with a “circle” in the list of usage environments is selected based on the operation performed by the user on the model selection screen of the client terminal 2 (Yes at S1211), the UI module 215 displays the model dependent information contained in the model dependent file of the model on the display unit of the client terminal 2 (S1212). FIG. 18 illustrates a display example of the model dependent information displayed on the display unit of the client terminal 2. If the UI module 215 displays the model dependent information on the display unit of the client terminal 2 (S1212), the client terminal 2 finishes the operation of displaying the list of models on the display unit.

While the explanation has been made of the image forming apparatuses and the printer driver that controls the image forming apparatuses in the present embodiment, application of the present invention is not limited thereto. The present invention is also applicable to a device incorporated in an information processing device, such as an expansion card including a network interface card (NIC), and a device driver of a peripheral device externally connected to the information processing device, such as an input-output device including a graphic display and a sound speaker.

While the explanation has been made on the assumption that the printer driver 210 and the installer 220 having the configuration described above are provided to the client terminal 2 in the present embodiment, they may be provided to the image forming apparatus 1. In this case, the image forming apparatus 1 stores the printer driver 210 and the installer 220 in a storage unit thereof, such as a non-volatile storage medium including the ROM 30 and the HDD 40. In this configuration, the client terminal 2 may acquire the printer driver 210 and the installer 220 from the image forming apparatus 1 via the network and the like as needed to perform the processing described in the present embodiment. A computer program that carries out the functions of the printer driver 210 and the installer 220 having the configuration described above may be stored in a portable storage medium. In this case, the computer program is stored in a format readable and executable by an information processing device, such as the client terminal 2.

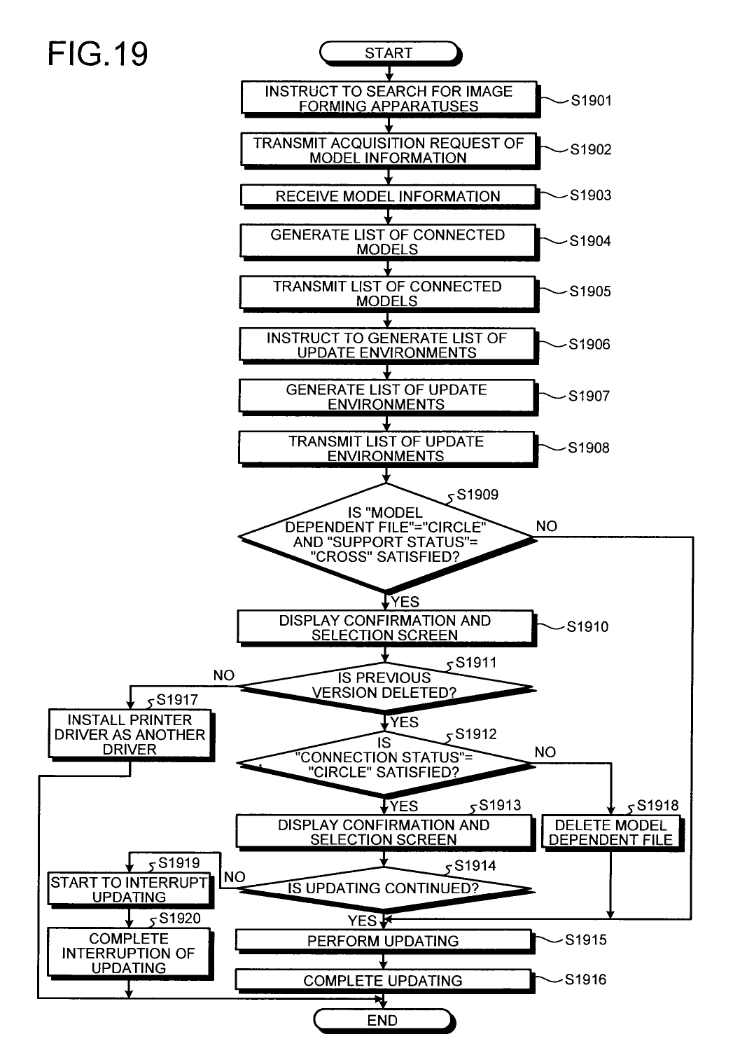

An explanation will be made of an operation of updating the printer driver 210 from Ver. 1.0 to Ver. 2.0 performed by the client terminal 2 according to a modification of the present embodiment with reference to FIG. 19. FIG. 19 is a flowchart for explaining the operation of updating the printer driver 210 from Ver. 1.0 to Ver. 2.0 according to the modification of the embodiment of the present invention.

Because processes from S1901 to S1908 in FIG. 19 are the same as those from S901 to S908 in FIG. 9, the explanation thereof will be omitted.

If the installation control unit 221 receives the list of update environments, the installation control unit 221 determines whether there is a model whose item of “model dependent file” is marked with a “circle” and whose item of “support status” is marked with a “cross” in the list of update environments (S1909). In other words, the installation control unit 221 determines whether the model dependent file storage unit 213 before being updated stores therein a model dependent file of a model unsupported by the printer driver of Ver. 2.0.

If the installation control unit 221 determines that there is no model whose item of “model dependent file” is marked with a “circle” and whose item of “support status” is marked with a “cross” in the list of update environments at S1909 (No at S1909), the installation control unit 221 performs updating without any change (S1915). To perform the updating at S1915, the installation control unit 221 generates model dependent files of models contained in the supported model information 211 and stores the model dependent files in the model dependent file storage unit 213. At this time, no model dependent file is generated for the models already stored in the model dependent file storage unit 213.

In this case (No at S1909), updating the printer driver 210 from Ver. 1.0 to Ver. 2.0 renders no model that has been supported before the updating unsupported and unavailable after the updating. Performing the updating without any change does not cause any inconvenience to the user. In this case (No at S1909), the installation control unit 221 performs the updating without any change. With this configuration, the client terminal 2 according to the modification of the present embodiment can automatically determine the system environment of the user to perform the updating. Thus, it is possible to reduce the troubles and improve the convenience of the user. After the updating is completed (S1916), the client terminal 2 finishes the operation of updating the printer driver 210 from Ver. 1.0 to Ver. 2.0.

By contrast, if the installation control unit 221 determines that there is a model whose item of “model dependent file” is marked with a “circle” and whose item of “support status” is marked with a “cross” in the list of update environments at S1909 (Yes at S1909), the installation control unit 221 displays a confirmation and selection screen that causes the user to select whether to install the printer driver 210 of the new version without deleting the printer driver 210 of the previous version on the display unit (display panel 104) of the client terminal 2 (S1910).

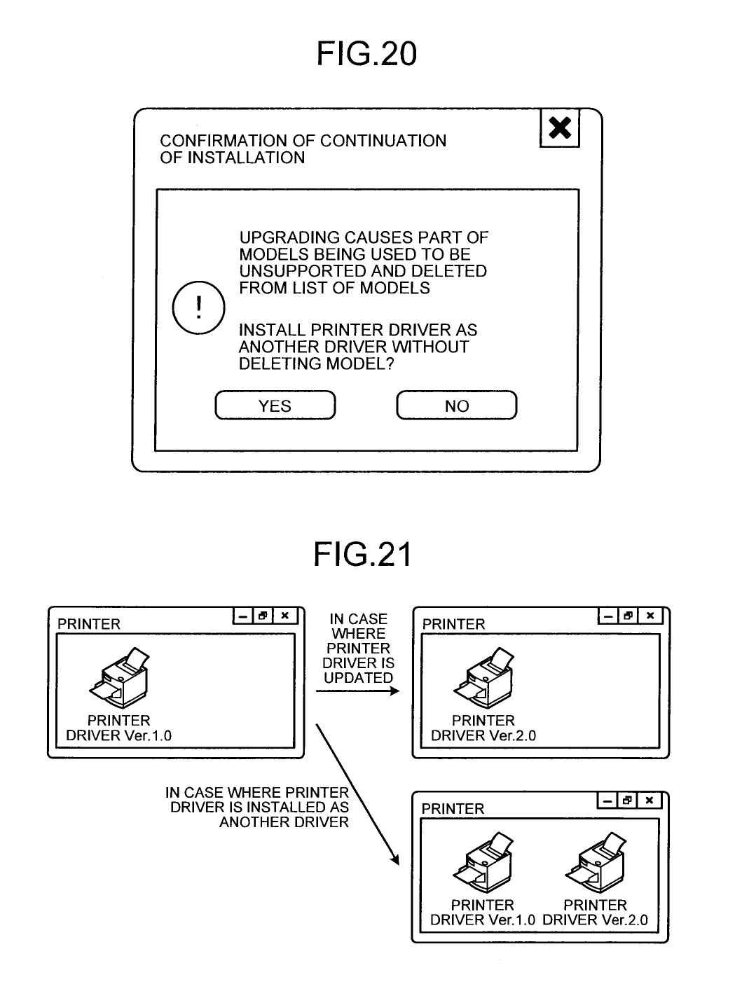

A display example of the confirmation and selection screen is illustrated in FIG. 20. FIG. 20 is a schematic of a display example of the confirmation and selection screen for an installation method displayed on the display unit of the client terminal 2 according to the modification of the present embodiment. As illustrated in FIG. 20, the user performs an operation in accordance with an instruction on the confirmation and selection screen displayed on the display screen of the client terminal 2 illustrated in FIG. 20, thereby selecting whether to install the printer driver 210 of the new version as another driver without deleting the printer driver 210 of the previous version. In other words, the confirmation and selection screen corresponds to the installation method selection screen, and the installation control unit 221 functions as the installation method selection screen display unit.

If the installation control unit 221 determines not to delete the printer driver 210 of the previous version based on the operation performed by the user on the confirmation and selection screen of the client terminal 2 (No at S1911), the installation control unit 221 installs the printer driver 210 after being updated as another driver (S1917). This allows the previous driver (printer driver 210 of the previous version) to remain. As a result, if the user desires to use a model that becomes unsupported after the updating, the user can use the model thus unsupported. The user can also use a model supported by the printer driver 210 of the new version by using the driver installed as another driver (printer driver 210 of the new version).

FIG. 21 is a schematic of a display example of printer icons displayed on the display unit of the client terminal 2 according to the modification of the embodiment of the present invention. As illustrated in FIG. 21, if the printer driver 210 of the previous version is updated, display of an icon of the printer driver 210 is changed from “printer driver Ver. 1.0” to “printer driver Ver. 2.0”. If the printer driver 210 of the new version is installed as another driver, the icon of the driver displayed as “printer driver Ver. 2.0” is displayed in addition to the icon of the driver displayed as “printer driver Ver. 1.0”.

If the installation control unit 221 determines to delete the printer driver 210 of the previous version based on the operation performed by the user on the confirmation and selection screen of the client terminal 2 (Yes at S1911), the installation control unit 221 checks the item of “connection status” of the model whose item of “model dependent file” is marked with a “circle” and whose item of “support status” is marked with a “cross” in the list of update environments to determine whether the model is connected to the client terminal 2 (S1912).

If the installation control unit 221 determines that a “cross” is allocated to the item of “connection status” of the model whose item of “model dependent file” is marked with a “circle” and whose item of “support status” is marked with a “cross” at S1912 (No at S1912), the installation control unit 221 deletes the model dependent file of the model (S1918). In the modification of the present embodiment, the list of update environments illustrated in FIG. 10 indicates that the model dependent file 213e of Model-E satisfying the conditions described above is deleted from the model dependent file storage unit 213. In other words, the installation control unit 221 functions as the determining unit and the model unique file deleting unit.

In this case (No at S1912), updating the printer driver 210 from Ver. 1.0 to Ver. 2.0 renders the model that has been supported before the updating unsupported and unavailable after the updating. Because the model has not been connected to the client terminal 2 before the updating, it is unlikely that the model is used after this. In this case (No at S1912), updating the printer driver 210 after deleting the model dependent file of the model does not cause any inconvenience to the user. Thus, the installation control unit 221 performs the updating after deleting the model dependent file of the model. In other words, the installation control unit 221 functions as the updating unit.

With this configuration, the client terminal 2 according to the modification of the present embodiment can automatically delete a useless model dependent file transparently. Thus, it is possible to lighten the system without causing troubles to the user. After deleting the model dependent file of the model, the installation control unit 221 performs the updating (S1915). After the updating is completed (S1916), the client terminal 2 finishes the operation of updating the printer driver 210 from Ver. 1.0 to Ver. 2.0.

If the installation control unit 221 determines that a “circle” is allocated to the item of “connection status” of the model whose item of “model dependent file” is marked with a “circle” and whose item of “support status” is marked with a “cross” at S1912 (Yes at S1912), the installation control unit 221 displays the confirmation and selection screen (refer to FIG. 11) that causes the user to select whether to continue the updating on the display unit (display panel 104) of the client terminal 2 (S1913). The user performs an operation in accordance with the instruction on the confirmation and selection screen displayed on the display screen of the client terminal 2 illustrated in FIG. 11, thereby selecting whether to continue the updating. In other words, the confirmation and selection screen corresponds to the performance selection screen, and the installation control unit 221 functions as the performance selection screen display unit.

The installation control unit 221 displays the confirmation and selection screen on the display unit of the client terminal 2, thereby enabling the user to explicitly select whether to continue the updating. With this configuration, the client terminal 2 according to the modification of the present embodiment can prevent an unexpected situation occurring in association with the updating, such as the image forming apparatus that has been used becoming unavailable without the user knowing it.

The confirmation and selection screen displayed at S1913 may display the list of models that become unavailable. Even if it is determined that a “circle” is allocated to the item of “connection status” of the model whose item of “model dependent file” is marked with a “circle” and whose item of “support status” is marked with a “cross” at S1912 (Yes at S1912), the confirmation and selection screen may not be displayed as long as the model is unsupported by the printer driver 210 before the installation, that is, the printer driver 210 of Ver. 1.0. This is because the model that has been unavailable for the user before the updating remains unavailable after the updating. In this case, updating without displaying the confirmation and selection screen does not cause any inconvenience to the user.

If the installation control unit 221 determines not to continue the updating based on the operation performed by the user on the confirmation and selection screen of the client terminal 2 (No at S1914), the installation control unit 221 starts to interruption operation of the updating (S1919). If the installation control unit 221 completes the interruption operation of the updating (S1920), the client terminal 2 interrupts the updating and finishes the process of updating the printer driver 210 from Ver. 1.0 to Ver. 2.0 on the way.

By contrast, if the installation control unit 221 determines to continue the updating based on the operation performed by the user on the confirmation and selection screen of the client terminal 2 (Yes at S1914), the installation control unit 221 continues the updating (S1915). At this time, the installation control unit 221 deletes no model dependent file in the modification of the present embodiment. As a result, the list of models on the model selection screen of the printer property after the updating displays Model-A supposed to be unsupported by the printer driver 210 of Ver. 2.0 in a selectable manner as illustrated in FIG. 16. In this configuration, the user can select Model-A thus unsupported but cannot set Model-A as an available printer as illustrated in FIG. 17. This prevents the user from erroneously operating the printer of Model-A.

In another embodiment, the installation control unit 221 may delete a model dependent file of a model unsupported by the printer driver 210 of Ver. 2.0 from the model dependent file storage unit 213 when performing the updating. With this configuration, the installation control unit 221 deletes the model dependent file 213a from the model dependent file storage unit 213 when performing the updating. As a result, the list of models on the model selection screen of the printer property after the updating does not display Model-A unsupported by the printer driver 210 of Ver. 2.0 from the first. With this configuration, the client terminal 2 according to the modification of the present embodiment displays no model that is unavailable in the system environment of the user on the model selection screen from the first. Thus, it is possible to eliminate troubles of the user.

If the installation control unit 221 completes the updating (S1916), the client terminal 2 finishes the operation of updating the printer driver 210 from Ver. 1.0 to Ver. 2.0.

By performing the operation described above, the model names of Model-A, Model-B, Model-C, Model-D, Model-F, and Model-G are stored in the model dependent file storage unit 213 after being updated as illustrated in FIG. 8.

According to the modification of the present embodiment, a user is allowed to choose not to delete the printer driver 210 of the previous version at S1910 and S1911, thereby causing the printer driver 210 of the previous version to coexist with the printer driver 210 of the new version in the updating of the printer driver 210.

According to the present invention, it is possible to improve the convenience of a user in updating a universal driver installed in an information processing device for controlling apparatuses with a simple configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device having an apparatus control program that provides a function to control an apparatus, the information processing device comprising:
a model unique file storage unit that stores therein a model unique file containing model unique information that varies depending on each model of the apparatus;
a model identification information list generating unit that acquires model identification information used for identifying a model of the apparatus from the apparatus to generate a model identification information list that lists the model identification information thus acquired;
a determining unit that, to update the apparatus control program, determines whether or not a model unique file of a first model is stored in the model unique file storage unit, the first model being contained neither in a list of models supported by the apparatus control program after being updated nor in the model identification information list;
a model unique file deleting unit that, when the determining unit determines that the model unique file of the first model is stored in the model unique file storage unit, deletes the model unique file of the first model from the model unique file storage unit; and
an updating unit that updates the apparatus control program when the model unique file deleting unit deletes the model unique file of the fist model.

2. The information processing device according to claim 1, further comprising a performance selection screen display unit that, to update the apparatus control program, when the model unique file of a second model is stored in the model unique file storage unit, displays a performance selection screen that causes an operator to select whether to continue updating of the apparatus control program, the second model being contained not in the list of models supported by the apparatus control program after being updated but in the model identification information list.

3. The information processing device according to claim 1, further comprising a property display unit that displays a property of the apparatus control program.

4. The information processing device according to claim 1, wherein, when the model unique files of models contained in the model identification information list are stored in the model unique file storage unit, the property display unit displays a list of those models on a model selection screen in a selectable manner.

5. The information processing device according to claim 1, wherein the property display unit displays no model whose model unique file is not stored in the model unique file storage unit on the model selection screen.

6. The information processing device according to claim 1, wherein the property display unit displays, on the model selection screen, no model that is contained in the model identification information list but is not listed in a list of supported models that lists models supported by the apparatus control program.

7. The information processing device according to claim 6, wherein, when a model that is not listed in the list of supported models is selected from the model selection screen, the property display unit displays a warning screen indicating that the model is unavailable.

8. The information processing device according to claim 6, wherein, when a model that is listed in the list of supported models is selected from the model selection screen, the property display unit displays the model unique information of the model.

9. The information processing device according to claim 1, further comprising an installation method selection screen display unit that, to update the apparatus control program, when the model unique file of a second model is stored in the model unique file storage unit, displays an installation method selection screen that causes an operator to select whether to install the apparatus control program after being updated as another apparatus control program without deleting the apparatus control program before being updated, the second model being contained not in the list of models supported by the apparatus control program after being updated but in the model identification information list.

10. A computer program product comprising a non-transitory computer-readable medium containing an apparatus control program for controlling an apparatus, the apparatus control program causing a computer, which includes a storage unit that stores therein a model unique file containing model unique information that varies depending on each model of the apparatus, to perform
acquiring model identification information used for identifying a model of the apparatus from the apparatus to generate a model identification information list that lists the model identification information thus acquired;
determining, to update the apparatus control program, whether or not a model unique file of a first model is stored in the storage unit, the first model being contained neither in a list of models supported by the apparatus control program after being updated nor in the model identification information list;
deleting, when it is determined that the model unique file of the first model is stored in the storage unit, the model unique file of the first model from the storage unit; and
updating the apparatus control program when the model unique file of the first model is deleted.

11. An image forming apparatus comprising:
a storage unit that stores therein the apparatus control program recited in claim 10.
